(19) United States
(12) Patent Application Publication
(10) Pub. No.: US 2022/0160010 A1
(43) Pub. Date: May 26, 2022

(54) USE OF EXTRUDED FRUIT AND/OR VEGETABLE WASTE AS AN ADDITIVE INCREASING THE VISCOSITY OF FOOD PRODUCTS

(71) Applicant: LUTKALA Sp. z o.o., Warszawa (PL)

(72) Inventor: Dariusz LUKA, Z?bki (PL)

(21) Appl. No.: 17/602,633

(22) PCT Filed: Apr. 4, 2020
(86) PCT No.: PCT/PL2020/050026

§ 371 Date: Oct. 8, 2021

(30) Foreign Application Priority Data
Apr. 9, 2019 (PL) PL429586

(51) Int. Cl. A23L 29/206; A23L 19/00; A23L 33/10

(52) U.S. Cl. CPC A23L 29/206; A23V 2002/00; A23L 33/10; A23L 19/09

(57) ABSTRACT

The use of waste from fruit and/or vegetables extruded at 105° C. to 180° C., namely sugar beet marc and/or apple pomace and/or currant pomace and/or chokeberry pomace and/or soya pomace as an additive to increase the viscosity of foodstuffs.

### FIELD OF THE INVENTION

The invention relates to a use of extruded waste from fruit and/or vegetables as an additive to increase the viscosity of foodstuffs.

Jams and preserves are thickened with sugar and/or pectins. When making home-made jams, which by assumption are supposed to be healthier and tastier than those commercially available, gelling sugar is used. The finished product often contains more of it than its commercially available counterpart. The minimum sugar content that is required for gelling mixes or gelling sugar is 350 g per 1 kg of fruit. Moreover, virtually all gelling mixes and gelling sugars additionally contain a preservative, usually sorbic acid or potassium sorbate. An alternative to gelling sugars and gelling mixes is to simmer fruit over a long period of time (sometimes several days) or collect the juice secreted by the fruit. This solution is not satisfactory. Firstly, it requires cooking one batch of fruit for several days, and secondly, the nutritional value is lost after such long period of cooking.

For this reason adding pectins is a much better solution. Pectins are commonly used in both domestic and industrial settings.

Pectins are a mixture of carbohydrates found in cell walls of numerous plants. Pectins are generally polysaccharides and oligosaccharides of variable composition. Pectins are primarily polyuronides consisting of D-galacturonic acid units interlinked by α-1,4-glycosidic bonds and largely esterified with methyl groups. Nutritionally, for humans pectins are ballasts. In terms of nutrition, they are a soluble dietary fibre fraction. Many micro-organisms are able to break down pectin. There are two fractions of pectin, depending on the degree of esterification:
high-methylated HM (or high-esterified HE), in which >50% of the carboxylic groups of the galacturonic acid residues are esterified;
low-methylated LM (or low-esterified LE), where the degree of esterification is less than 50%.

The common feature of pectins is the ability to form gels under acidic conditions. The gelification capacity depends on the degree of pectin methylation. Pectins are used in food industry as a thickener. Among others, pectins are responsible for the solidification of jams and fruit spreads.

Pectins consist of three main carbohydrate types:
homogalacturonate—a polysaccharide composed of galacturonic acid mers
rhamnogalacturonate I—a polysaccharide composed of dimers (rhamnose+galacturonic acid)
rhamnogalacturonate II—a branched polysaccharide.
   Pectin content in various plants:

apple: 1-1.5%

common apricot: 1%

cherry: 0.4%

orange: 0.5-3.5%

carrot: 1.4%

citrus zest: 30%

GB 461200 patent description discloses a method for producing pectins from apple pomace, consisting of extracting the pomace with diluted hydrochloric acid, concentrating the extract, precipitating pectins with alcohol, drying and grinding. The conditions of the extraction process, however, involve hydrolysis of the glycosides and degradation of aglycones.

The journal Innovative Food Science Emerging Technologies 4 (2003) 99-107 and WO 01788 53A1 patent description disclose a process for recovering pectins and polyphenols from apple pomace extracts acidified to pH 2.8 with hydrochloric acid, which is adsorbed in an adsorption resin bed (Amberlite XAD 16HP), from which pectins are extracted by way of desorption with water, and polyphenols—by way of desorption with methanol. The pectin fraction is concentrated, the pectin is precipitated with ethanol and dried, and the solvent is distilled from the methanol solution of polyphenols, and the residue is lyophilized to yield about 12% polyphenol concentrate containing about 33% phlorizin and not less than 20% quercetin glycosides. Concentrated polyphenolic extracts, in liquid and solid forms, obtained from apple pomace or from fraction of inlay of seed cores or stalks of the pomace, are used to enrich fruit preparations.

Although pectins are commonly used both in households and in industry, it is still necessary to use sugar. Moreover, despite the use of fully natural raw material such as fruit pomace, it is necessary to carry out a number of complex technological and chemical processes.

As is known, sugar, especially in large quantities, is not a desirable ingredient in foodstuffs. Even though at a household level we have some influence on how preserves are prepared, it is not the case with commonly consumed commercially available products.

The addition of fruit or vegetable pomace to foodstuffs is also known, the low availability of pectins in pomace, however, requires this raw material to be added in large quantities, which often changes the taste of the dish. Cherry jam, which is one of the more difficult jams to be thickened, if it contains a large amount of apple pomace, it no longer has the desired cherry taste.

The process of processing raw materials and materials of biological origin for food or feed purposes by pumping them through extruders under high pressure and at high temperature into a cooling chamber is called extrusion. Extrusion is used to improve digestibility of nutrients.

The following are obtained with the extrusion method:
breakfast components such as snacks, chips, cereals,
feed for pets and fish,
instant noodles, that do not require cooking,
crispy bread,
instant drinks and baby nutrients,
multi-ingredient, high-processed meat analogues.

There is still a need to seek fully natural thickeners without the need to use sophisticated chemical processing or to add sugar.

### DISCLOSURE OF THE INVENTION

In the light of the described state of the art, the aim of this invention is to overcome the indicated inconveniences and provide fully natural viscosity-enhancing thickeners for foodstuffs without the need to use complex chemical processing, and that will exert the effect of increasing the viscosity of foodstuffs even without added sugar.

Surprisingly, it was found that the waste from some fruit and vegetables not subjected to any chemical processes, but only properly performed extrusion process, is an excellent additive that increases the viscosity of foodstuffs. Therefore/as a result it can be used instead of known thickeners to increase the viscosity of liquid foodstuffs.

The invention therefore relates to the use of extruded waste from fruit and/or vegetables, namely sugar beet marc and/or apple pomace and/or currant pomace and/or chokeberry pomace and/or soybean pomace as an additive to increase the viscosity of foodstuffs.

Preferably in the use, fruit and/or vegetable waste used was extruded at temperatures from 105° C. to approx. 180° C., more preferably in the range of 140° C. to 160° C.
Preferably in the use, the waste from fruit and/or vegetables used was brought to a moisture content in the range of 18 to 20% by weight before being extruded.

Dried selected fruit and/or vegetable waste are brought to a moisture content of 18 to 20% by weight by adding water to commercial dried products, or drying fresh pomace and marc to a moisture content of 18 to 20%, and then fed to a heated screw extruder. The extruder is heated to a temperature of 105° C. to 180° C. The extrusion process is carried out co that the extrudate is continuously collected, then cooled down, left to air-dry or dried, and subsequently grounded and sifted.

After adding water and before the extrusion process, fruit pomace is preferably left for about an hour.

The obtained extrudates were tested for their ability to thicken jams. The results obtained indicate that the selected products are capable of fully replacing pectins and sugar. Jams and preserves of the expected thickness are obtained, with different amounts of extrudates being used depending on the fruit and source thereof. The resulting thickener is completely natural, it has not been subjected to any chemical treatment processes, and, what is more, a full value thickener based on raw material which has not been fully utilized so far has been achieved. It was unexpectedly found that selected extruded waste from fruit and/or vegetables has a better ability to thicken foodstuffs such as jams compared to non-extruded waste. In addition, there is no strict correlation between the ability to gel jams with the addition of extrudates according to the invention and the pectin content of the raw materials. Accordingly, it can be assumed that the ability to thicken jams is not due to the increased availability of pectins in the extruded raw material. The assumption that the greater amount of pectins contained in the waste raw material implies a greater ability to thicken the fruit has been found to be contrary to expectations. Orange pomace should theoretically be potentially the best raw material due to its high pectin content, while in fact they were found to be unusable.

The extrudates obtained can be used as an additive increasing the viscosity of food and beverage products containing water, particularly preferably jams, ketchups, mustards, sauces, jellies, soups, puddings, dairy products, yoghurts etc. The use of completely natural extruded waste from sugar beet marc, apple pomace, currant pomace, chokeberry pomace, soybean pomace or mixtures thereof instead of sugars or chemically processed pectin or other thickeners allows not only to increase the viscosity of food and beverage products, but also to increase their taste variety and provide additional nutrients, vitamins and minerals contained therein. Thus, the use of the resulting extrudates according to the invention provides improved, more ecological and healthier food and beverage products.

The object of the invention has been illustrated by examples that do not limit its scope.

### EXAMPLES

### Example 1

The procedure for obtaining extrudates according to the invention was as follows:

I. Establishing Extrusion Conditions
1. Testing of water content in dried pomace or beet marc. The amount of water ranged from 8% to 11% for fruit pomace by weight depending on the raw material and its origin.
2. Adding water to the samples in the amount necessary to obtain a water content of 10%, 20% and 30% by weight.
3. Leaving the raw material with water for 1 hour.
4. Feeding of raw material to a twin screw extruder with an extrusion head heated in successive experiments to a temperature of: 80° C., 100° C., 105° C., 110° C., 120° C., 140° C., 160° C., 180° C. and 190° C. with the screw rotating at 800 rpm.
5. Extrudate drying and grinding
6. Testing of samples for their ability to thicken plum, apricot, strawberry and raspberry jams.
7. Sugar beet marc, apple pomace, soybean pomace, currant pomace, carrot pomace, chicory pomace, orange pomace, pear pomace, chokeberry pomace was tested.

With a water content of 10%, the screw was unable to move the raw material in the extruder. The process was stopped. With 30% water content, no extrusion was observed.

The best results were obtained for water content of 18% to 20% by weight. Therefore, the waste had to be either hydrated or dried to the required humidity of 18 to 20% by weight.

It was found that extrusion takes place at a temperature of 105° C. to approx. 180° C. It was the most effective at 140° C. to 160° C. At above 190° C., the marc is burnt (charred). Outside the range defined as the most effective, extrusion products have poorer thickening properties.

The extrudate was collected and left in open boxes until the next day. Meanwhile it was cooled and dried. The next day, the extrudate was ground and sieved, and put aside for further examination. The jams with samples were then cooked.

The fruit for jam was divided into groups:
extruded samples were added to the first one
dried pomace was added to the second one
dried pomace and sugar were added to the third one
extruded samples and sugar were added to the fourth one
pectin was added to the fifth one

For comparison purposes, the same amounts of fruit and additives were used in the groups, with amounts varying depending on the fruit. Both fresh and frozen fruit were examined, with frozen fruit coming from different producers, which was marked in the table as A, B and C.

The results are summarised in Table 1 below, where ‘b’ means no additive. Dynamic viscosity in the range 50.00-30,000 mPas was measured by Brookfield method using a rotational viscometer. The measured viscosity was a measure of the ability to gel, i.e. to generate a product having a jam texture.

TABLE 1

| | | | | | |
|---|---|---|---|---|---|
| Fruit | Extrudate | Dried pomace | Sugar | Pectin | Viscosity mPas |

Fresh fruit

| | | | | | |
|---|---|---|---|---|---|
| plums (300 g) | b | apple 5 g | b | b | 2479 |
| plums (300 g) | apple 5 g | b | b | b | 3441 |
| plums (300 g) | apple 5 g | b | 50 g | b | 3293 |
| plums (300 g) | b | b | b | 5 g | 7232 |
| plums (300 g) | b | soybean 5 g | b | b | 2850 |
| plums (300 g) | b | soybean 5 g | 50 g | b | 2274 |
| plums (300 g) | soybean 5 g | b | b | b | 3778 |
| plums (300 g) | soybean 5 g | b | 50 g | b | 3765 |
| plums (300 g) | b | b | 50 g | 5 g | 7612 |
| plums (300 g) | b | oranges 5 g | b | b | 2224 |
| plums (300 g) | oranges 5 g | b | b | b | 2383 |
| plums (300 g) | chokeberry 5 g | b | b | b | 2054 |
| plums (300 g) | b | chokeberry 5 g | b | b | 1970 |
| plums (300 g) | carrot 5 g | b | b | b | 2116 |
| plums (300 g) | b | carrot 5 g | b | b | 2637 |
| apricots (300 g) | b | apple 5 g | b | b | 2020 |
| apricots (300 g) | apple 5 g | b | b | b | 3841 |
| apricots (300 g) | b | soybean 5 g | b | b | 2471 |
| apricots (300 g) | soybean 5 g | b | b | b | 4614 |
| apricots (300 g) | b | oranges 5 g | b | b | 5170 |
| apricots (300 g) | oranges 5 g | b | b | b | 2934 |

Frozen fruit

| | | | | | |
|---|---|---|---|---|---|
| Plums A (540 g) | b | b | b | b | 2780 |
| Plums A (540 g) | b | b | b | 9 g | 13096 |
| Plums A (540 g) | b | b | 90 g | 9 g | 13816 |
| Plums A (540 g) | sugar beet 18 g | b | b | b | >15000 |
| Plums A (540 g) | sugar beet 18 g | b | 90 g | b | 12863 |
| Plums A (540 g) | b | sugar beet 18 g | b | b | 4307 |
| Plums A (540 g) | b | sugar beet 18 g | 90 g | b | 4162 |
| Plums A (540 g) | chicory 18 g | b | b | b | 3640 |
| Plums A (540 g) | orange 18 g | b | b | b | 5191 |
| Plums A (540 g) | carrot 18 g | b | b | b | 5330 |
| Plums A (540 g) | currant 18 g | b | b | b | 3578 |
| Plums A (540 g) | pear 18 g | b | b | b | 3231 |
| Plums A (540 g) | b | chicory 18 g | b | b | 3587 |
| Plums A (540 g) | b | orange 18 g | b | b | 7510 |
| Plums A (540 g) | b | carrot 18 g | b | b | 4230 |
| Plums A (540 g) | b | currant 18 g | b | b | 3174 |
| Plums A (540 g) | b | pear 18 g | b | b | 3441 |
| strawberries | b | b | b | b | 1869 |
| (540 g) | | | | | |
| strawberries | b | b | b | 9 g | >15000 |
| (540 g) | | | | | |
| strawberries | b | b | 90 g | 9 g | >15000 |
| (540 g) | | | | | |
| strawberries | sugar beet 18 g | b | b | b | >15000 |
| (540 g) | | | | | |
| strawberries | sugar beet 18 g | b | 90 g | b | 5860 |
| (540 g) | | | | | |
| strawberries | b | sugar beet 18 g | b | b | 2520 |
| (540 g) | | | | | |
| strawberries | b | sugar beet 18 g | 90 g | b | 2358 |
| (540 g) | | | | | |
| strawberries | apple 18 g | b | b | b | 5746 |
| (540 g) | | | | | |
| strawberries | apple 18 g | b | 90 g | b | 4995 |
| (540 g) | | | | | |
| strawberries | b | apple 18 g | b | b | 2233 |
| (540 g) | | | | | |
| strawberries | b | apple 18 g | 90 g | b | 2258 |
| (540 g) | | | | | |
| raspberries | b | b | b | b | 1453 |
| (540 g) | | | | | |
| raspberries | b | b | b | 9 g | 6045 |
| (540 g) | | | | | |
| raspberries | b | b | 90 g | 9 g | 6217 |
| (540 g) | | | | | |
| raspberries | sugar beet 18 g | b | b | b | 6105 |
| (540 g) | | | | | |
| raspberries | sugar beet 18 g | b | 90 g | b | 5157 |
| (540 g) | | | | | |
| raspberries | b | sugar beet 18 g | b | b | 2826 |
| (540 g) | | | | | |
| raspberries | b | sugar beet 18 g | 90 g | b | 3026 |
| (540 g) | | | | | |
| raspberries | apple 18 g | b | b | b | 5949 |
| (540 g) | | | | | |
| raspberries | apple 18 g | b | 90 g | b | 5255 |
| (540 g) | | | | | |
| raspberries | b | apple 18 g | b | b | 2781 |
| (540 g) | | | | | |
| raspberries | b | apple 18 g | 90 g | b | 5918 |
| (540 g) | | | | | |
| Plums B (540 g) | b | b | b | b | 1664 |
| Plums B (540 g) | apple 18 g | b | b | b | 5782 |
| Plums B (540 g) | apple 18 g | b | 90 g | b | 4821 |
| Plums B (540 g) | b | apple 18 g | b | b | 2289 |
| Plums B (540 g) | b | apple 18 g | 90 g | b | 2623 |
| Plums B (540 g) | sugar beet 18 g | b | b | b | 6978 |
| Plums B (540 g) | orange 18 g | b | b | b | 3099 |
| Plums B (510 g) | carrot 17 g | b | b | b | 3114 |
| Plums C (540 g) | b | b | b | b | 3752 |
| Plums C (540 g) | b | b | b | 9 g | >15000 |
| Plums C (540 g) | b | b | b | 9 g | >15000 |
| Plums C (540 g) | apple 18 g | b | b | b | 8196 |
| Plums C (540 g) | apple 18 g | b | b | b | 8031 |
| Plums C (540 g) | sugar beet 18 g | b | b | b | >15000 |
| Plums C (540 g) | sugar beet 18 g | b | b | b | >15000 |
| Plums C (540 g) | | sugar beet 18 g | b | b | 6110 |
| Plums C (540 g) | | sugar beet 18 g | b | b | 7355 |
| Plums C (540 g) | apple 5.5 g (1%) | b | b | b | 5449 |
| Plums C (540 g) | apple 11 g (2%) | b | b | b | 5590 |
| Plums C (540 g) | apple 16.7 g (3%) | b | b | b | 7630 |
| Plums C (540 g) | apple 22.5 g (4%) | b | b | b | 14893 |
| Plums C (540 g) | apple 28.4 g (5%) | b | b | b | >15000 |
| Plums C (540 g) | sugar beet 5.5 g (1%) | b | b | b | 5884 |
| Plums C (540 g) | sugar beet 11 g (2%) | b | b | b | 6769 |
| Plums C (540 g) | sugar beet 16.7 g (3%) | b | b | b | 14837 |
| Plums C (540 g) | sugar beet 22.5 g (4%) | b | b | b | >15000 |
| Plums C (540 g) | sugar beet 28.4 g (5%) | b | b | b | >15000 |

### Presentation of the Results

The carried out tests allowed for the following conclusions and observations to be drawn:
the best results were obtained for water content of 18% to 20% by weight.
the extrusion should be carried out at a temperature of 105° C. to 180° C.,
extrusion products have surprising properties:
   a) some extrusion products, namely oranges, carrot and pears, have characteristics that are inferior to those of the raw material,
   b) extrusion products whose properties have improved compared to the raw material show a deterioration in properties after the addition of sugar (commonly used thickener),
   (c) orange pomace, which has the most pectin, shows deterioration in its properties following the extrusion.
      As shown by the carried out tests on the properties of viscosity-increasing foodstuffs using extrudates according to the invention, they do not depend on either the sugar content or the pectin content of the starting material, and the mechanism of thickening products containing water using extrudates is different and unknown and depends on the starting material as well as the properly conducted extrusion method.

1. The use of waste from fruit and/or vegetables extruded at 105° C. to 180° C. selected from sugar beet marc and/or apple pomace and/or currant pomace and/or chokeberry pomace and/or soybean pomace as an additive to increase the viscosity of foodstuffs.

2. The use according to claim 1, wherein fruit and/or vegetable waste was extruded at a temperature between 140° C. and 160° C.

3. The use according to claim 1, wherein the waste from fruit and/or vegetables was brought to a moisture content of 18-20% by weight before being extruded.
